(19) United States
(12) Patent Application Publication
(10) Pub. No.: US 2023/0100680 A1
(43) Pub. Date: Mar. 30, 2023

(54) Q-Switch

(71) Applicant: Fanjun Liu, Vancouver (CA)

(72) Inventor: Fanjun Liu, Vancouver (CA)

(21) Appl. No.: 17/948,131

(22) Filed: Sep. 19, 2022

Related U.S. Application Data
(60) Provisional application No. 63/223,470, filed on Jul. 19, 2021.

(51) Int. Cl. F16M 11/16

(52) U.S. Cl. CPC F16M 11/16

(57) ABSTRACT

Disclosed is a quick release system for attaching different types of heads onto a tripod or monopod.

The current application claims a priority to the U.S. provisional patent application Ser. No. 63/223,470 filed on Jul. 19, 2021. The U.S. provisional patent application 63/223,470 is revived within the two-month period for unintentional abandonment by Sep. 19, 2022.

### FIELD OF THE INVENTION

The present invention relates generally to hunting and photo equipment. More specifically, an apparatus that allows for easy change for different type of heads using the same tripod or monopod.

### BACKGROUND OF THE INVENTION

A photographic tripod and monopod are portable devices used to support, stabilize and elevate a camera. The camera is attached to the tripod or monopod through a mounting head, which typically requires a screw or similar hardware connection piece to fasten the two components.

### BRIEF DESCRIPTION OF THE DRAWINGS

FIG. 1 is an illustration of the present invention.

### DETAIL DESCRIPTIONS OF THE INVENTION

All illustrations of the drawings are for the purpose of describing selected versions of the present invention and are not intended to limit the scope of the present invention.

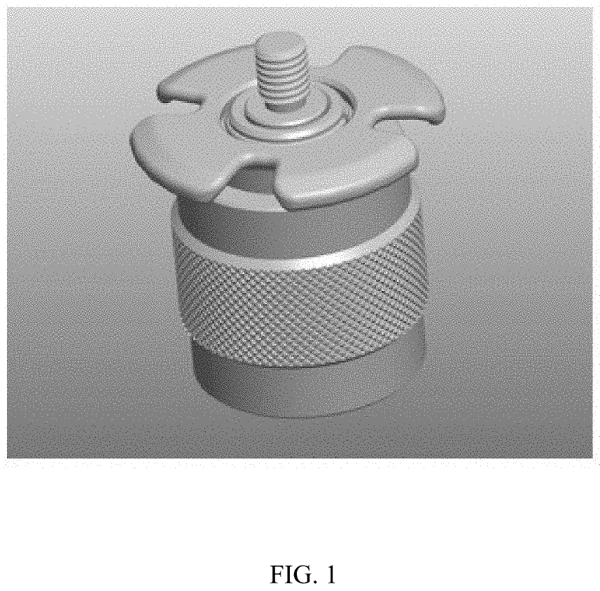

The present invention, herein referred to as “Q-Switch”, is an apparatus/accessory for hunting and photo equipment that allows for easy change for different type of heads using the same tripod or monopod. Q-Switch comprises a quick release system (illustrated in FIG. 1).

Although the invention has been explained in relation to its preferred embodiment, it is to be understood that many other possible modifications and variations can be made without departing from the spirit and scope of the invention.

What is claimed is:

1. A quick release system for attaching different types of heads onto a tripod or monopod.
